(19) United States
(12) Patent Application Publication
(10) Pub. No.: US 2018/0053126 A1
(43) Pub. Date: Feb. 22, 2018

(54) PLATFORM AND METHOD FOR TRANSFERRING BUSINESS

(71) Applicant: Real Estate Team, Inc., Virginia Beach, VA (US)

(72) Inventor: Kris Allen Weaver, Virginia Beach, VA (US)

(73) Assignee: Real Estate Team, Inc., Virginia Beach, VA (US)

(21) Appl. No.: 15/242,010

(22) Filed: Aug. 19, 2016

(51) Int. Cl. G06Q 10/06

(52) U.S. Cl. CPC G06Q 10/0631; G06Q 10/0637; G06Q 10/067

(57) ABSTRACT

A platform for transferring business is described. Users use registration logic to open accounts. A first user submits a business with a unique identifier. Second, third and further users bid on the business using bidding logic and a winning bid normally corresponds with a bid for a higher profit sharing percentage to share with the first user. When a benefit is registered in favor of a winning bidder, the benefit is divided between the winning bidder, the first user and an operator of the platform.

### BACKGROUND OF THE INVENTION

The invention relates to a platform and to a method for transferring business.

### SUMMARY OF THE INVENTION

The invention provides a platform for transferring business including a processor, a data store connected to the processor, a computer readable medium connected to the processor and a set of instructions on the computer readable medium that is executable by the processor. The set of instructions includes a business registry on the data store, a business reception unit receiving a business from a first user device, the business identifying a first user, a business registering unit registering the business in the business registry, a request reception unit receiving a request for the business from a second user device, the request including a second user, a business allocation unit recording the second user in association with the business in the business registry, a benefit detection unit receiving an indication of a benefit for a benefit amount in favor of the second user for the business, a benefit registering unit registering the indication of the benefit in association with the business in the business registry and a billing unit recording, in response to the registration of the benefit, an amount owed by the second user to the first user, the amount owed being a portion of the benefit amount.

The platform may further include that the business includes a unique identifier, the benefit detection unit providing the unique identifier to the benefit registering unit, the benefit registering unit determining a select business with the unique identifier among a plurality of businesses with respective unique identifiers, wherein the benefit registering unit registers the indication of the benefit in association with the select business.

The platform may further include that the benefit detection unit enters the unique identifier into a business registration server and the business registration server returns a result for the unique identifier, the benefit being based on the result from the business registration server.

The platform may further include that the benefit detection unit includes a business detection unit that receives a business amount and a benefit calculation unit that calculates the benefit as a portion of the business amount.

The platform may further include that the benefit is a percentage of the business amount.

The platform may further include an agreement displayed to the second user at the second user device and an agreement recording logic that receives an acceptance of the agreement, wherein the second user is only recorded in association with the business if the acceptance of the agreement is received.

The platform may further include a first fractioning unit determining a transfer portion and profit remainder of the benefit, wherein the profit remainder is recorded for the benefit of the second user and a second fractioning unit determining a first portion of the transfer portion and a second portion of the transfer portion, wherein the amount owed by the second user to the first use is the first portion and the second portion is held back for the benefit of an operator of the processor.

The platform may further include a business presentation module presenting the business to a plurality of bidding users at a plurality of respective bidding user devices, a bidding reception unit receiving a bid from each of the bidding user devices and a winning bid determination unit determining the winning bid based at least in part on the bids, wherein the second user device is the bidding device associated with the winning bid.

The platform may further include that each bid includes a profit sharing factor and the winning bid based on the profit sharing factors of the bids, further including an amount calculation unit that calculates the amount owed by the second user to the first user based on the profit sharing factor of the winning bid.

The platform may further include that the profit sharing factor is a percentage of the benefit.

The invention also provides a computer-based method of transferring business including establishing, by a processor, a business registry on a data store, receiving, by the processor, a business from a first user device, the business identifying a first user, registering, by the processor, the business in the business registry, receiving, by the processor, a request for the business from a second user device, the request including a second user, recording, by the processor, the second user in association with the business in the business registry, receiving, by the processor, an indication of a benefit for a benefit amount in favor of the second user for the business, registering, by the processor, the indication of the benefit in association with the business in the business registry and recording, by the processor, in response to the registration of the benefit, an amount owed by the second user to the first user, the amount owed being a portion of the benefit amount.

The method may further include that the business includes a unique identifier, further including determining, by the processor, a select business with the unique identifier among a plurality of businesses with respective unique identifiers, wherein the indication of the benefit is registered in association with the select business.

The method may further include entering, by the processor, the unique identifier into a business registration server and the business registration server returns a result for the unique identifier, the benefit being based on the result from the business registration server.

The method may further include receiving, by the processor, a business amount and calculating, by the processor, the benefit as a portion of the business amount.

The method may further include that the benefit is a percentage of the business amount.

The platform method may further include displaying, by the processor, an agreement to the second user at the second user device and receiving, by the processor, an acceptance of the agreement, wherein the second user is only recorded in association with the business if the acceptance of the agreement is received.

The method may further include determining, by the processor, a transfer portion and profit remainder of the benefit, wherein the profit remainder is recorded for the benefit of the second user and determining, by the processor, a first portion of the transfer portion and a second portion of the transfer portion, wherein the amount owed by the second user to the first use is the first portion and the second portion is held back for the benefit of an operator of the processor.

The method may further include presenting, by the processor, the business to a plurality of bidding users at a plurality of respective bidding user devices, receiving, by the processor, a bid from each of the bidding user devices and determining, by the processor, a winning bid based at least in part on the bids, wherein the second user device is the bidding device associated with the winning bid.

The method may further include that each bid includes a profit sharing factor and the winning bid based on the profit sharing factors of the bids, further including calculating, by the processor, the amount owed by the second user to the first user based on the profit sharing factor of the winning bid.

The method may further include that the profit sharing factor is a percentage of the benefit.

### BRIEF DESCRIPTION OF THE DRAWINGS

The invention is further described by way of example with reference to the accompanying drawings, wherein:

FIG. 1 is a block diagram of a network environment illustrating a platform for transferring business according to an embodiment of the invention and first and second user devices;

FIG. 2 is a block diagram further illustrating components of the platform including a bidding engine, a benefit detection unit and a benefit registering unit;

FIG. 3 is a block diagram illustrating components of the platform including first and second fractioning units;

FIGS. 4A and 4B are a flow chart of a computer based method of transferring business;

FIG. 5 is a block diagram of the user devices illustrating SmartPhone features thereof; and

FIG. 6 is a block diagram of a machine in the form of a computer system forming part of the network environment.

### DETAILED DESCRIPTION OF THE INVENTION

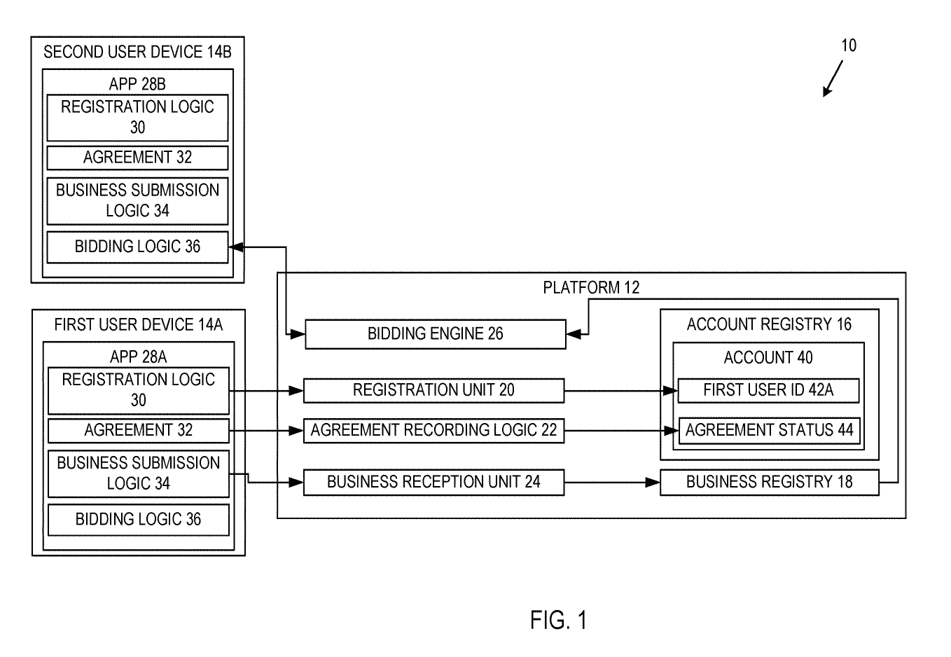

FIG. 1 of the accompanying drawings illustrates a network environment 10, according to an embodiment of the invention, that includes a platform 12 for transferring business and first and second user devices 14A and 14B.

The platform 12 includes an account registry 16, a business registry 18, a registration unit 20, an agreement recording logic 22, a business reception unit 24 and a bidding engine 26.

The first user device 14A includes a mobile application (App) 28A. The App 28A includes a registration logic 30, an agreement 32, a business submission logic 34 and a bidding logic 36. The second user device includes an App 28B that includes the same component as App 28A.

A first user of the first user device 14A uses the registration logic 30 to interact with the registration unit 20 for purposes of establishing an account 40. The registration logic 30 is used to enter a first user identifier (ID) 42A, such as a name, email address or phone number. The registration logic 30 then transmits the first user ID 42A to the registration unit 20. The registration unit 20 receives the first user ID 2A from the first user device 14A and then establishes an account 40 in the account registry 16 that includes a first user ID 42A.

The App 28A then proceeds to display the agreement 32 on a display of the first user device 14A. The App 28A does not take any further action until the user accepts the agreement 32. When the user accepts the agreement 32, the App 28A transmits the acceptance of the agreement to the agreement recording logic 22. The agreement recording logic 22 receives the acceptance of the agreement and enters the acceptance of the agreement as an agreement status 44 within the account 40. Only when the agreement status 44 indicates that the agreement 32 has been accepted by the first user, does the App 28A allow the first user to use other features of the App 28A including the business submission logic 34 and the bidding logic 36.

Similarly, a second user, at the second user device 14B, uses the App 28B to establish an account (not shown) within the account registry 16. The App 28B includes the same components as the App 28A. The user of the second user device 14B has to accept the agreement 32 of the App 28B before being permitted to use the business submission logic 34 or the bidding logic 36 of the App 28B.

For purposes of discussion, the first user device 14A is used for submitting a business using the business submission logic 34 of the App 28A and the second user device 14B is used for bidding on the business and receiving the business using the bidding logic 36 of the App 28B. It should however be noted that the App 28B includes a business submission logic 34 for submitting a business and the App 28A includes a bidding logic 36 for bidding on a business and receiving the business. A single agreement 32 within a respective App 28A or 28B permits the use of the respective App 28A or 28B for either submission of a business or bidding on a business and receiving the business.

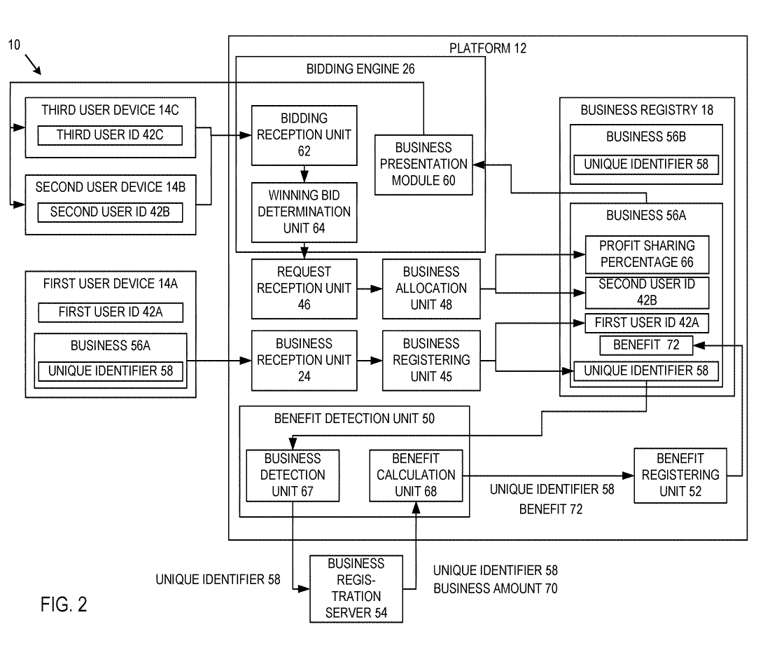

FIG. 2 shows components of the network environment 10 in more detail. The platform 12 includes a business registering unit 45, a request reception unit 46, a business allocation unit 48, a benefit detection unit 50 and a benefit registering unit 52. In addition to the first and second user devices 14A and 14B, a third user device 14C is shown. Each user device 14A to 14C includes a respective user identifier 42A to 42C. Each user identifier 42A to 42C is used to identify the respective user and their user device within the account registry 16 shown in FIG. 1.

The network environment 10 further includes a business registration server 54 that is in communication with the benefit detection unit 50.

The first user of the first user device 14A uses the business submission logic 34 in FIG. 1 to enter a business 56A with a unique identifier 58 into memory of the first user device 14A. The unique identifier 58 may for example be a physical address of a property that is being offered for sale, or the like. The business submission logic 34 transmits the business 56A with the unique identifier 58 to the business reception unit 24. The first user ID 42A is stored on the first user device 14A or is entered by the first user of the first user device 14A. The business submission logic 34 transmits the first user ID 42A together with the business 56A to the business reception unit 24.

The business reception unit 24 receives the business 56A with the unique identifier 58 and the first user ID 42A from the first user device 14A. The business reception unit 24 then enters the data that has been received into the business registering unit 45. The business registering unit 45 registers the business 56A within the business registry 18 together with the unique identifier 58 and the first user ID 42A.

One or more users may enter one or more businesses within the business registry 18. The business registry 18 shows a further business 56B that has been entered together with its own unique identifier 58 that differs from the unique identifier of the business 56A. Further details of the business 56B, such as a user ID and other data that is associated with the business 56B, are similar to the business 56A.

The bidding engine 26 includes a business presentation module 60, a bidding reception unit 62 and a winning bid determination unit 64. The business presentation module 60 extracts the business 56A from the business registry 18 and transmits the business 56A to the second and third user devices 14B and 14C. The business presentation module 60 may for example send an email to the second and third user devices 14B and 14C and include the unique identifier 58 of the business 56A.

Each device 14B and 14C has a respective App with a respective bidding logic such as the bidding logic 36 shown in FIG. 1 that can also be used to display at least the unique identifier 58 of the business 56A on a respective screen of a respective device 14B or 14C. The users of the devices 14B and 14C may then enter a bid for the business using the bidding logic 36 and transmit the bid to the bidding reception unit 62. For example, the second user may enter a bid for a profit sharing percentage of 40% representing the percentage of a benefit that the second user of the second user device 14B is willing to share with the first user of the first user device 14A. The third user of the third user device 14C may then enter a bid with a profit sharing percentage of 45%.

The bidding reception unit 62 receives the bids from the second and third user devices 14B and 14C and enters the bids into the winding bid determination unit 64. The winning bid determination unit 64 determines a winning bid based at least in part on the bids from the second and third user devices 14B and 14C. Typically, the bid having the highest profit sharing percentage is the winning bid. Other factors such as reputation, location, etc. may be additional factors that may also be considered in order to determine a winning bid. For purposes of further discussion, it is assumed that the winning bid is the final bid received from the second user device 14B. By way of example, the winning bid from the second user device 14B is for a profit sharing percentage of 60%.

The winning bid determination unit 64 provides the winning bid to the request reception unit 46. The request reception unit 46 then enters the winning bid into the business allocation unit 48. The business allocation unit 48 then registers the profit sharing percentage 66 and the second user ID 42B in association with the business 56A.

The first and second users may for example be real estate agents. The first user may have obtained the contract to sell a property having a physical address as represented by the unique identifier 58. The first user has referred the business 56A to the second user. When the business 56A is allocated to the second user, the second user may then proceed to sell the property on behalf of its owner for purposes of receiving a benefit in the form of a commission. By way of example, the second user may sell the property for 1 million dollars for purposes of receiving a commission of 6% or $60,000 USD. When the business is sold, the sale is recorded within the business registration server 54 together with the sale price.

The benefit detection unit 50 includes a business detection unit 67 and a benefit calculation unit 68. The business detection unit 67 extracts the unique identifier 58 from the business 56A in the business registry 18 and enters the unique identifier 58 into the business registration server 54. The platform 12 is typically connected to the business registration server 54 over the Internet. The business registration server 54 then returns the unique identifier 58 together with a business amount 70. In the present example, the business amount 70 is the sale price of 1 million dollars. The benefit calculation unit 68 receives the unique identifier 58 and the business amount 70 from the business registration server 54. The benefit calculation unit 68 then calculates a benefit based on the business amount 70. In a typical real estate sale, the benefit calculation unit 68 multiplies the sale amount by a typical percentage of 6% to determine the benefit. In the present example, the benefit calculation unit 68 multiplies the sale price of 1 million dollars by 6% to determine a benefit in the form of a commission of $60,000 USD.

The benefit calculation unit 68 provides the unique identifier 58 together with a benefit 72 that has been calculated by the benefit calculation unit 68 to the benefit registering unit 52. The benefit registering unit 52 then enters the benefit 72 in association with the business 56A.

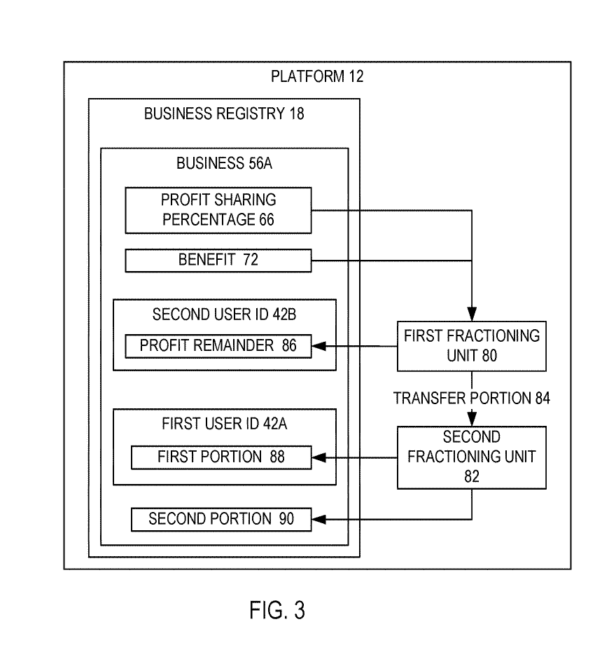

FIG. 3 illustrates further components of the platform 12, including a first fractioning unit 80 and a second fractioning unit 82. The first fractioning unit 80 receives the profit sharing percentage 66 and the benefit 72 from the business 56A in the business registry 18. The first fractioning unit 80 then calculates a transfer portion 84 and a profit remainder 86 based on the profit sharing percentage 66 and the benefit 72. The transfer portion 84 is the benefit 72 multiplied by the profit sharing percentage 66.

In the present example, the transfer portion 84 is $36,000 USD representing the benefit 72 of $60,000 USD multiplied by the profit sharing percentage 66 of 60%. The profit remainder 86 is the difference between the benefit 72 and the transfer portion 84. In the present example, the profit remainder 86 is $24,000 USD representing the difference between the benefit 72 of $60,000 USD and the transfer portion 84 of $36,000 USD.

The first fractioning unit 80 enters the profit remainder 86 in association with the second user ID 42B for the respective business 56A. The first fractioning unit 80 enters the transfer portion 84 into the second fractioning unit 82.

The second fractioning unit 82 then calculates a first portion 88 and a second portion 90. The second fractioning unit 82 enters the first portion 88 in association with the first user ID 42A for the respective business 56A and enters the second portion 90 in association with respective business 56A. The first and second portions 88 and 90 represent profit sharing between the first user and an operator of the platform 12 according to the agreement 32 of the first user device 14A in FIG. 1.

The first portion 88 may for example be $27,000 USD representing 75% of the $36,000 USD transfer portion 84 and the second portion 90 may be $9,000 USD representing 25% of the $36,000 USD transfer portion 84, with the first and second portions 88 and 90 adding up to 100% of the transfer portion 84.

It can thus be seen that the benefit 72 of $60,000 USD is divided into the profit remainder 86 of $24,000 USD, the first portion 88 of $27,000 USD and the second portion 90 of $9,000 USD. In a real estate transaction the amounts of the benefit 72, profit remainder 86, first portion 88 and second portion 90 are allocated to respective parties during closing. Alternatively, a system may include functionality to transfer the amounts between stored value accounts, bank accounts or the like.

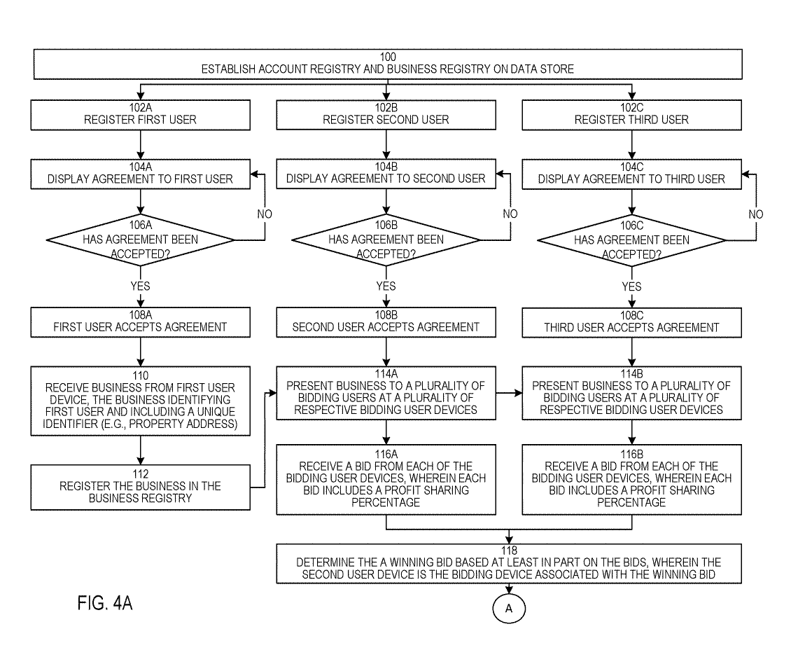

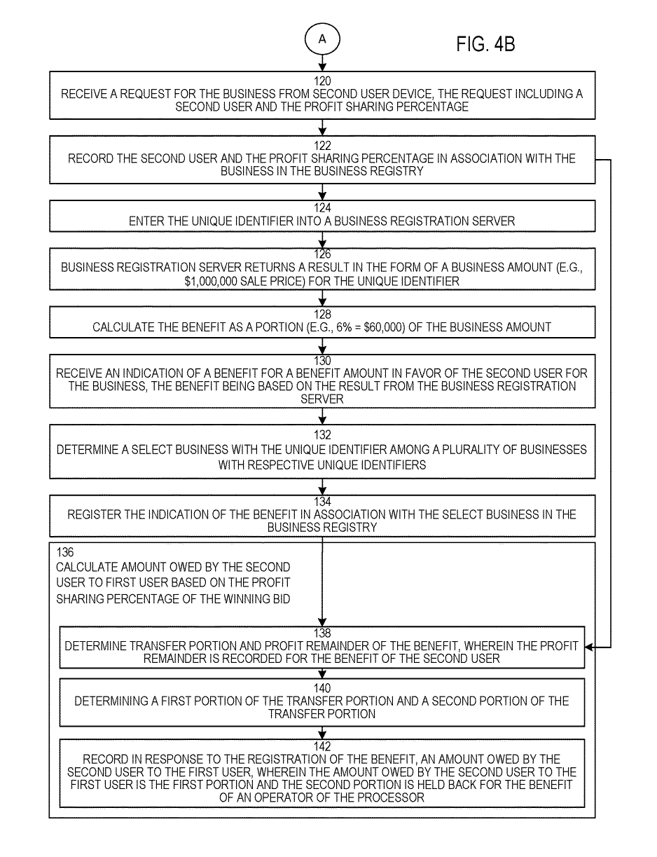

FIG. 4A illustrates a computer based method of transferring business according to an embodiment of the invention. At 100, an account registry and a business registry are established on a data store (FIG. 1: 16, 18). At 102A, a first user is registered (FIG. 1: 40). At 104A, an agreement is displayed to the first user (FIG. 1: 32). At 106A, a determination is made whether the first user has accepted the agreement (by the agreement recording logic 32 in FIG. 1). At 108A, the first user accepts the agreement.

Similarly, at 102B and C, second and third users are registered. At 104B and C, the agreement is displayed to the second and third users, at 106B and C, a determination is made whether the second and third users have accepted the agreement, and 108B and C, the second and third users accept the agreement.

At 110, a business is received from the first user device. The business identifies the first user and includes the unique identifier (e.g. the property address) (FIG. 2:24). At 112, the business is registered in the business registry (FIG. 2:45, 42A, 58). The system cannot proceed to 110 before the first user accepts the agreement at 108A.

At 114A and B, the business is presented to a plurality of bidding users at a plurality of respective bidding user devices. In the present example, the business is presented to the second and third user devices. (FIG. 2: 60). At 116A and B, a bid is received from each of the bidding user devices. Each bid includes a profit sharing percentage (FIG. 2: 62). At 118, a winning bid is determined based at least in part on the bids. In the present example, the second user device is the bidding device associated with the winning bid. (FIG. 2: 64).

FIG. 4B further illustrates the computer based method of transferring business. At 120, a request is received for the business from the second user device. The request includes the second user and the profit sharing percentage (FIG. 2: 46). At 122, the second user and the profit sharing percentage are recorded in association with a business in the business registry (FIG. 2:48, 42B, 66).

At 124, the unique identifier is entered into a business registration server. (FIG. 2: 66, 54). At 126, the business registration server returns a result in the form of a business amount (e.g., 1 million dollar sale price) for the unique identifier (FIG. 2: 54, 68). At 128, a benefit is calculated as a portion (e.g., 6%=$60,000 USD) of the business amount (FIG. 2: 68). At 130, an indication of the benefit for the benefit amount in favor of the second user for the business is received (FIG. 2: 52). At 132, a select business with the unique identifier is determined among a plurality of businesses with respective unique identifiers (in FIG. 2, the business registering unit 52 uses the unique identifier 58 to find the business 56A among the businesses 56A and 56B). At 134, the indication of the benefit is registered in association with the select business (FIG. 2: 52, 72).

At 136, generally, the amount owed by the second user to the first user is calculated based on the profit sharing percentage of the winning bid. At 138, the transfer portion and profit remainder of the benefit is determined. The profit remainder is recorded for the benefit of the second user. Block 122 is connected to block 138 to indicate that the profit sharing percentage is used to calculate the transfer portion (FIG. 3: 66, 72, 80, 84, 86). At 140, the first portion of the transfer portion and the second portion of the transfer portion are determined (FIG. 3: 82, 88, 90). At 142, in response to the registration of the benefit (at 134), an amount owed by the second user to the first user is recorded. The amount owned by the second user to the first user is the first portion and the second portion is held back for the benefit of an operator of the platform 12 and its associated data stores and processors.

It can thus be seen that a referral reward can be provided by the second user to the first user after the first user makes the business available to the second user. The referral reward can be calculated based on bidding for profit share percentages by the second and third users. Various components of the system allow for detection and calculation of portions that are allocated to the first and second users and the operator of the platform.

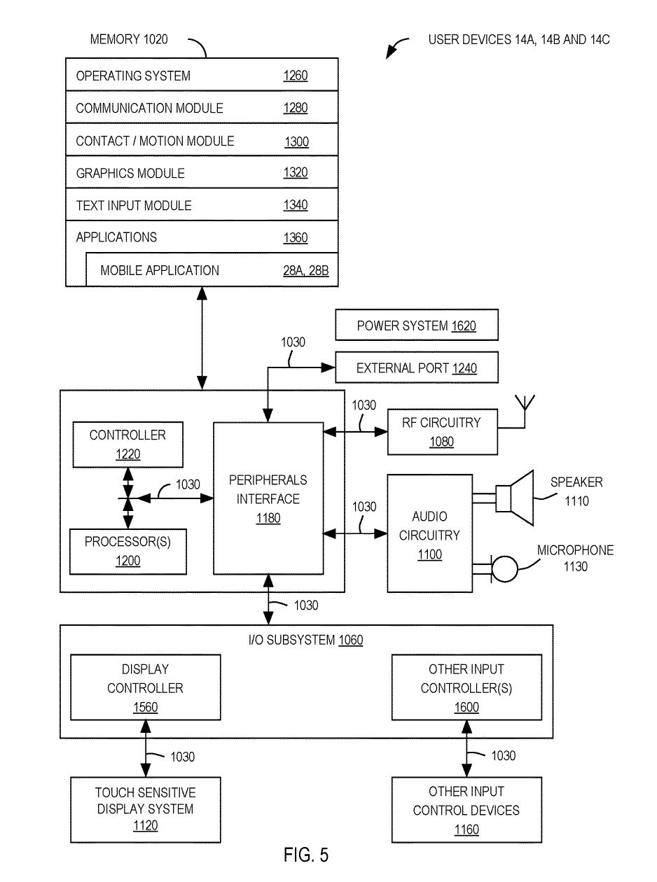

FIG. 5 is a block diagram illustrating the mobile devices 14A, 14B and 14C, illustrating a touch-sensitive display 1120 or a “touch screen” for convenience. The mobile devices 14A, 14B and 14C include a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 5 may be implemented in hardware, software or a combination of hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the mobile devices 14A, 14B and 14C, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the mobile devices 14A, 14B and 14C and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the mobile devices 14A, 14B and 14C. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the mobile devices 14A, 14B and 14C, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the mobile devices 14A, 14B and 14C on or off. The touch screen 1120 is used to implement virtual or soft buttons and one or more soft keyboards.

The touch-sensitive touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The mobile devices 14A, 14B and 14C also include a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., iOS, Android or Windows) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), LIGHTNING, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include the mobile applications 28A and 28B.

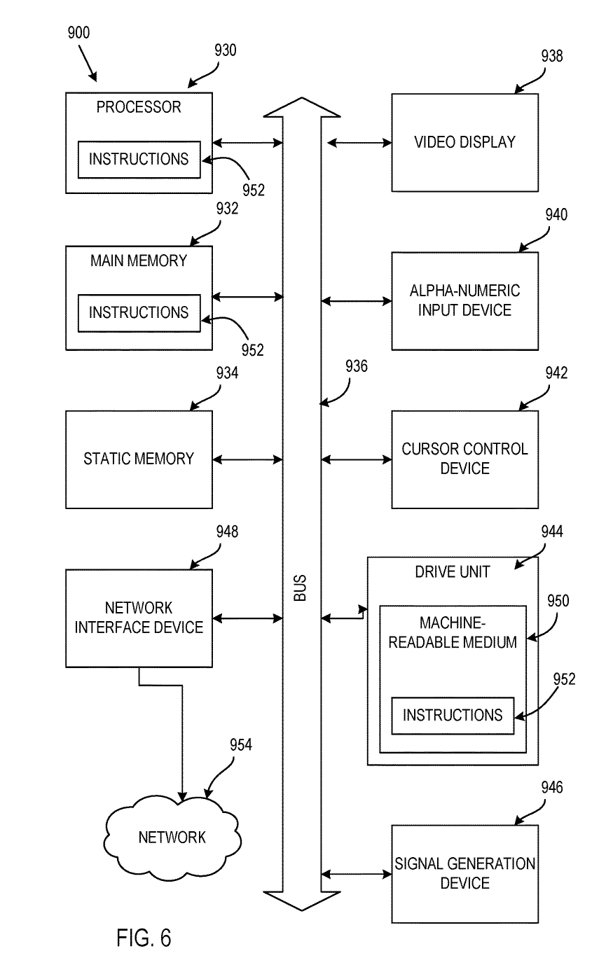

FIG. 6 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A platform for transferring business comprising:
a processor;
a data store connected to the processor;
a computer readable medium connected to the processor;
a set of instructions on the computer readable medium that is executable by the processor, including:
a business registry on the data store;
a business reception unit receiving a business from a first user device, the business identifying a first user;
a business registering unit registering the business in the business registry;
a request reception unit receiving a request for the business from a second user device, the request including a second user;
a business allocation unit recording the second user in association with the business in the business registry;
a benefit detection unit receiving an indication of a benefit for a benefit amount in favor of the second user for the business;
a benefit registering unit registering the indication of the benefit in association with the business in the business registry; and
a billing unit recording, in response to the registration of the benefit, an amount owed by the second user to the first user, the amount owed being a portion of the benefit amount.

2. The platform of claim 1, wherein the business includes a unique identifier, the benefit detection unit providing the unique identifier to the benefit registering unit, the benefit registering unit determining a select business with the unique identifier among a plurality of businesses with respective unique identifiers, wherein the benefit registering unit registers the indication of the benefit in association with the select business.

3. The platform of claim 1, wherein the benefit detection unit enters the unique identifier into a business registration server and the business registration server returns a result for the unique identifier, the benefit being based on the result from the business registration server.

4. The platform of claim 1, wherein the benefit detection unit includes:
a business detection unit that receives a business amount; and
a benefit calculation unit that calculates the benefit as a portion of the business amount.

5. The platform of claim 4, wherein the benefit is a percentage of the business amount.

6. The platform of claim 1, further comprising:
an agreement displayed to the second user at the second user device; and
an agreement recording logic that receives an acceptance of the agreement, wherein the second user is only recorded in association with the business if the acceptance of the agreement is received.

7. The platform of claim 1, further comprising:
a first fractioning unit determining a transfer portion and profit remainder of the benefit, wherein the profit remainder is recorded for the benefit of the second user; and
a second fractioning unit determining a first portion of the transfer portion and a second portion of the transfer portion, wherein the amount owed by the second user to the first use is the first portion and the second portion is held back for the benefit of an operator of the processor.

8. The platform of claim 1, further comprising:
a business presentation module presenting the business to a plurality of bidding users at a plurality of respective bidding user devices;
a bidding reception unit receiving a bid from each of the bidding user devices; and
a winning bid determination unit determining the winning bid based at least in part on the bids, wherein the second user device is the bidding device associated with the winning bid.

9. The platform of claim 8, wherein each bid includes a profit sharing factor and the winning bid based on the profit sharing factors of the bids, further comprising:
an amount calculation unit that calculates the amount owed by the second user to the first user based on the profit sharing factor of the winning bid.

10. The platform of claim 9, wherein the profit sharing factor is a percentage of the benefit.

11. A computer-based method of transferring business comprising:
establishing, by a processor, a business registry on a data store;
receiving, by the processor, a business from a first user device, the business identifying a first user;
registering, by the processor, the business in the business registry;
receiving, by the processor, a request for the business from a second user device, the request including a second user;
recording, by the processor, the second user in association with the business in the business registry;
receiving, by the processor, an indication of a benefit for a benefit amount in favor of the second user for the business;
registering, by the processor, the indication of the benefit in association with the business in the business registry; and
recording, by the processor, in response to the registration of the benefit, an amount owed by the second user to the first user, the amount owed being a portion of the benefit amount.

12. The method of claim 11, wherein the business includes a unique identifier, further comprising:
determining, by the processor, a select business with the unique identifier among a plurality of businesses with respective unique identifiers, wherein the indication of the benefit is registered in association with the select business.

13. The method of claim 11, further comprising:
entering, by the processor, the unique identifier into a business registration server and the business registration server returns a result for the unique identifier, the benefit being based on the result from the business registration server.

14. The method of claim 11, further comprising:
receiving, by the processor, a business amount; and
calculating, by the processor, the benefit as a portion of the business amount.

15. The method of claim 14, wherein the benefit is a percentage of the business amount.

16. The method of claim 11, further comprising:
displaying, by the processor, an agreement to the second user at the second user device; and
receiving, by the processor, an acceptance of the agreement, wherein the second user is only recorded in association with the business if the acceptance of the agreement is received.

17. The method of claim 11, further comprising:
determining, by the processor, a transfer portion and profit remainder of the benefit, wherein the profit remainder is recorded for the benefit of the second user; and
determining, by the processor, a first portion of the transfer portion and a second portion of the transfer portion, wherein the amount owed by the second user to the first use is the first portion and the second portion is held back for the benefit of an operator of the processor.

18. The method of claim 11, further comprising:
presenting, by the processor, the business to a plurality of bidding users at a plurality of respective bidding user devices;
receiving, by the processor, a bid from each of the bidding user devices; and
determining, by the processor, a winning bid based at least in part on the bids, wherein the second user device is the bidding device associated with the winning bid.

19. The method of claim 18, wherein each bid includes a profit sharing factor and the winning bid based on the profit sharing factors of the bids, further comprising:
calculating, by the processor, the amount owed by the second user to the first user based on the profit sharing factor of the winning bid.

20. The method of claim 19, wherein the profit sharing factor is a percentage of the benefit.
